(19) United States
(12) Patent Application Publication
(10) Pub. No.: US 2009/0261219 A1
(43) Pub. Date: Oct. 22, 2009

(54) ON-VEHICLE HOLDER OF A PORTABLE ELECTRONIC DISPLAY DEVICE

(75) Inventor: Stephen Chen, Changhua (TW)

Correspondence Address: ROGER H. CHU, 19499 ERIC DRIVE, SARATOGA, CA, 95070, US

(73) Assignee: E-LEAD ELECTRONIC CO., LTD., Shengang Shiang (TW)

(21) Appl. No.: 12/107,076

(22) Filed: Apr. 22, 2008

(51) Int. Cl. A47F 5/00; F16B 47/00

(52) U.S. Cl. 248/206.2; 248/316.2

(57) ABSTRACT

An on-vehicle holder of a portable electronic display device comprises a support bracket, a U-shaped base and a movable engagement member. The U-shaped base is connected to the support bracket, comprising a first lateral plate, a second lateral plate and a bottom plate connecting together; a containing space portion is made by the first lateral plate, the second lateral plate and the bottom plate. The movable engagement member comprises an operating portion and a fastener portion. In addition, at least either the length of the first lateral plate or the length of the second lateral plate is longer than the width of the bottom plate. Consequently, the structure of the invention is made to contain the thickness of a portable electronic display device to achieve the objective of design miniaturization.

### FIELD OF THE INVENTION

The present invention relates to an on-vehicle holder, especially an on-vehicle holder of a portable electronic display device, e.g., an on-vehicle CD player, an in-car GPS navigation system, etc., which is applicable for use in a vehicle.

### BACKGROUND OF THE INVENTION

With the increasing development of automotive electronics technologies, there are diversified in-car electronic devices on the market for selection, such as a portable electronic display device, an on-vehicle CD player, an in-car GPS navigation system, etc.; those portable electronic display devices have become basic on-vehicle requirements.

An on-vehicle holder is used to retain diversified portable electronic display devices, a conventional holder is designed as a claw or a clutch on a fixed bracket to hold a portable electronic display device stably in a vehicle.

Each convenient portable electronic display device has a specific bracket, namely, the size of a bracket for each portable electronic display device differs. Therefore, if a vehicle is equipped with a plurality of portable electronic display devices, there are plural brackets to match the plurality of portable electronic display devices.

When a portable electronic display device is in use or taken away from its holder, the holder is placed on the same position in a vehicle above the panel, which easily hinder a driver's view.

Prior arts of U.S. Pat. No. 6,955,280, No. 6,827,318, No. 6,758,521, No. 6,234,435, No. 6,213,438, No. 5,996,866 and No. 5,964,601 mainly are improvements of conventional on-vehicle holder structures, such as the positioning method of an on-vehicle holder, the retaining method of a portable electronic display device, etc. Similar on-vehicle holder products of prior arts have remained the problems of complicated structures of prior arts, diversified holder sizes, etc., unsolved so that those products are unable to achieve ideal functions for drivers. Therefore, how to enable an on-vehicle holder to be more convenient for use with a compact size is a practicable improvement direction.

### SUMMARY OF THE INVENTION

In view of the forgoing defects of conventional techniques, an on-vehicle holder of a portable electronic display device is disclosed hereafter, which comprises a support bracket, a U-shaped base and a movable engagement member.

The U-shaped base is connected to the support bracket, comprising a first lateral plate, a second lateral plate and a bottom plate. The bottom plate is connected to the second lateral plate and the first lateral plate, in addition, a containing space portion is formed by the second lateral plate, the first lateral plate and the bottom plate.

Moreover, the movable engagement member is pivotally positioned in the second lateral plate of the U-shaped base and moved around the lateral plate; in addition, the movable engagement member comprises an operating portion and a fastener portion.

When a driver operates the operating portion of the movable engagement member, enabling the movable engagement member to move around the second lateral plate of the U-shaped base and the fastener portion to move around toward the direction of the containing space portion, in addition, at least either the length of the first lateral plate or the length of the second lateral plate is longer than the width of the bottom plate.

Therefore, the main objective of the invention is to provide a compact on-vehicle holder enabling diversified portable electronic display devices to be retained for use, so as to achieve the objectives of the design miniaturization and increasing convenient applications to a driver.

The aforementioned support bracket in accordance with the invention is a flexible shaft, therefore, the bendable property of the flexible shaft enables a driver to adjust a portable electronic display device to a proper visual angle; in addition, the invention is able to be bent to a proper angle not to hinder the driver's view when the portable electronic display device is removed from its on-vehicle holder.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective view showing a first preferred embodiment of the invention;

FIG. 2 is a cross-sectional view of the first preferred embodiment of the invention;

FIG. 3 is second cross-sectional view of the first preferred embodiment of the invention;

FIG. 4 is a 3D perspective view showing a second preferred embodiment of the invention;

FIG. 5 is a cross-sectional view showing a second preferred embodiment of the invention;

FIG. 6 is a 3D perspective view showing a third preferred embodiment of the invention; and

FIG. 7 is a 3D perspective view showing a fourth preferred embodiment of the invention.

### DETAILED DESCRIPTION OF THE INVENTION

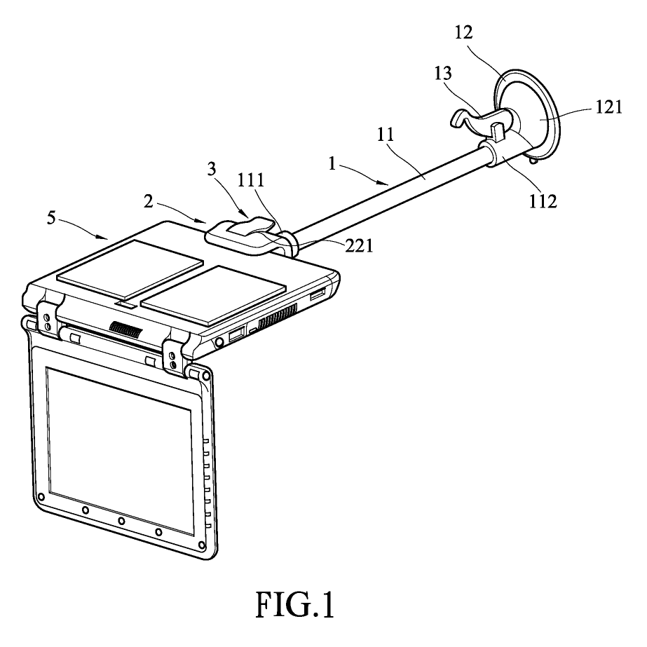

The invention discloses an on-vehicle holder of a portable electronic display device herein. With reference to FIG. 1, the on-vehicle holder of a portable electronic display device comprises a portable electronic display device 5, which is a CD player in this preferred embodiment.

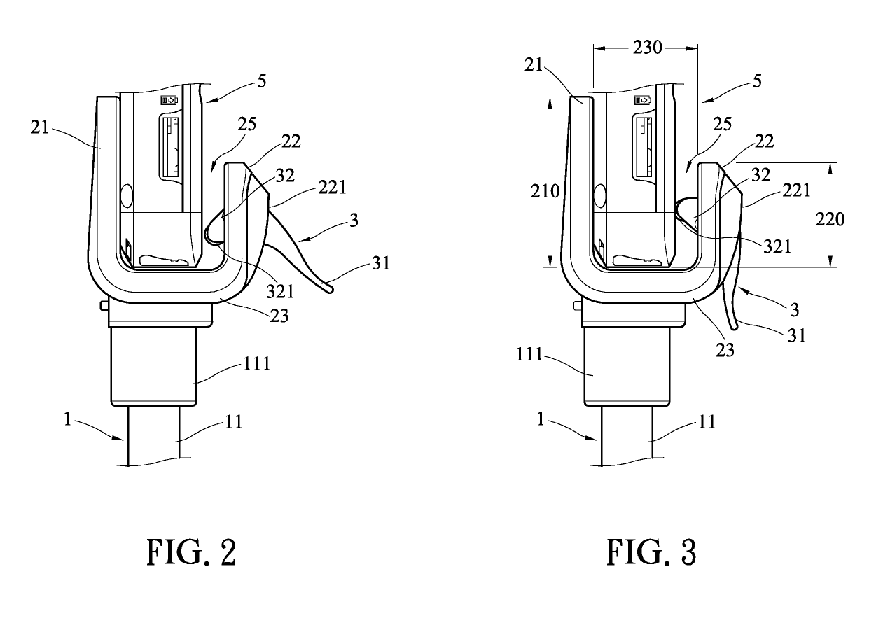

As the first embodiment shown in FIGS. 1 and 2, the on-vehicle holder of a portable electronic display device comprises a support bracket 1, a U-shaped base 2 and a movable engagement member 3.

The support bracket 1 in this preferred embodiment is a shaft 11, which comprises a first end 111 and a second end 112. The first end 111 of the shaft 11 is connected to the U-shaped base 2, the second end 112 of the shaft 11 has a vacuum sucking disk 12 positioned thereon. As shown in the preferred embodiment, the vacuum sucking disk 12 is a soft plastic cup-shaped body, comprising a raised portion 121, a cam 13 is pivotally set on a position near the end 112 of the shaft 11, the cam 13 is positioned against the raised portion 121 of the vacuum sucking disk 12 and moved around corresponding to the shaft 11.

Moreover, the U-shaped base 2 comprises a first lateral plate 21, a second lateral plate 22 and a bottom plate 23; the bottom plate 23 is connected with the first lateral plate 21 and the second lateral plate 22, meanwhile, a containing space portion 25 is surrounded by the first lateral plate 21, the second lateral plate 22 and the bottom plate 23.

In addition, the movable engagement member 3 is a engagement cam, which is pivotally set in the second lateral plate 22 of the U-shaped base 2 and moved around corresponding to the second lateral plate 22. The movable engagement member 3 comprises an operating portion 31 and a fastener portion 32, wherein the fastener portion 32 comprises a wheel 321 pivotally set thereon.

In this preferred embodiment, the second lateral plate 22 of the U-shaped base comprises a through aperture 221; the through aperture 221 is penetrated the containing space portion 25, and the movable engagement member 3 is pierced through the through aperture 221 and pivotally set on the second lateral plate 22 of the U-shaped base.

With reference to FIGS. 1, 2 and 3, the vacuum sucking disk 12 on the second end 112 of the shaft 11 is stuck on a vehicle windscreen (not shown), enabling the top of the cam 13 to be against the raised portion 121 on the vacuum sucking disk 12 and moved around the shaft 11, so that the vacuum sucking disk 12 is able to tightly attached to the vehicle windscreen (not shown).

Subsequently, when the portable electronic display device 5 is positioned inside the containing space portion 25 of the U-shaped base 2 and a driver applies strength to the operating portion 31 on the movable engagement member 3, thereby enabling the movable engagement member 3 to move around corresponding to the second lateral plate 22 of the U-shaped base 2 and enabling the fastener portion 32 of the movable engagement member 3 to move around toward the containing space portion 25. Consequently, the fastener portion 32 of the movable engagement member 3 is able to tightly retain the portable electronic display device 5, in addition, the wheel 321 pivotally set on the fastener portion 32 of the movable engagement member 3 is able to roll and retain the portable electronic display device 5 in the containing space portion 25. Moreover, the invention enables a driver to apply strength to the movable engagement member 3 without generating friction and ensures that the portable electronic display device 5 is not damaged during the operation.

Therefore, the invention enables diversified portable electronic display devices 5, regardless of the size, to be placed inside the containing space portion 25 of the U-shaped base 2, in addition, enables the movable engagement member 3 to tightly retain the portable electronic display device 5 inside. The invention is convenient to each driver who needs to place diversified portable electronic display devices 5 in an on-vehicle holder.

In the preferred embodiment, the first lateral plate 21 of the U-shaped base 2 includes a length of the first lateral plate 210, the second lateral plate 22 of the U-shaped base 2 includes a length of the second lateral plate 220, and the bottom plate includes a width of the bottom plate 230; in addition, at least either the length of the first lateral plate 210 or the length of the second lateral plate 220 is longer than the width of the bottom plate 230. Therefore, the portable electronic display device 5 is easily placed inside the containing space portion 25 of the U-shaped base 2, without the falling down possibility. Consequently, the invention achieves the design miniaturization of the U-shaped base 2.

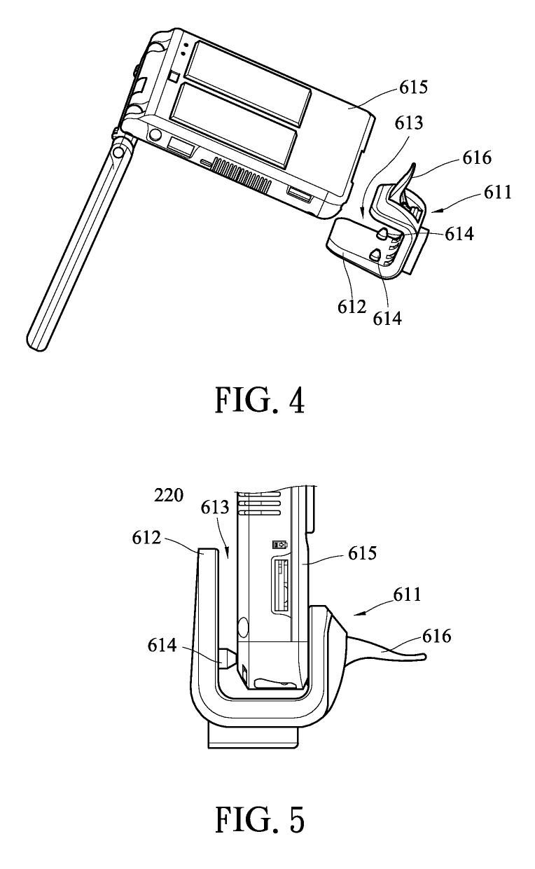

FIGS. 4 and 5 show a second preferred embodiment in accordance with the invention. In the preferred embodiment, the main structure is the same as in the first embodiment; the only difference lies in that a lateral plate 612 of a U-shaped base 611 comprises a fixed engagement member positioned on the surface facing the containing space portion 613 and is at least a raised point. In this preferred embodiment, the fixed engagement member becomes two plastic raised points 614; therefore, when a driver operates a movable engagement member 616 to enable a portable electronic display device 615 to be placed inside the containing space portion 613 of the U-shaped base 611, there is space remained.

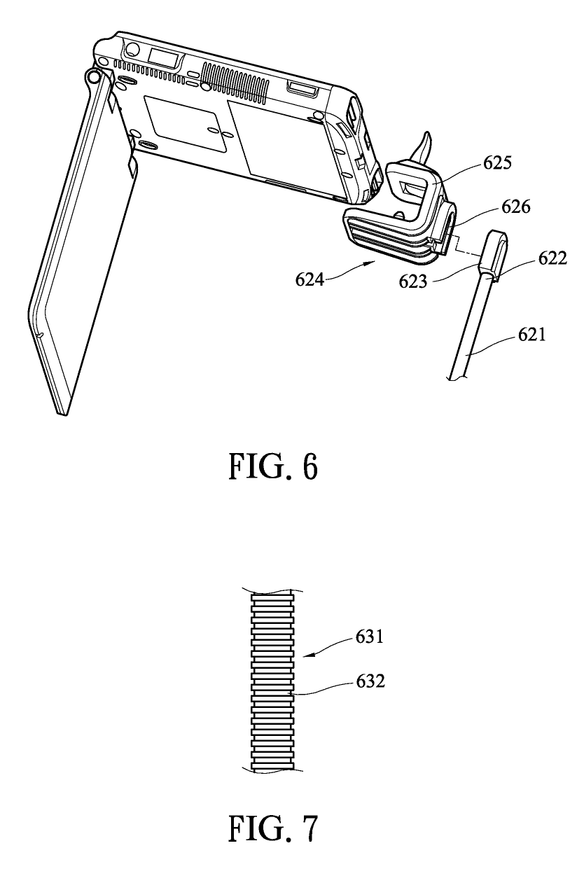

FIG. 6 shows a third preferred embodiment that the main structure is the same as in the first preferred embodiment; the only difference lies in that an end 622 of a shaft 621 comprises a slide 623, a groove 626 is positioned on a bottom plate 625 of the U-shaped base 624, so that the slide 623 on the end 622 of the shaft 621 is correspondently coupled to the groove 626, thereby enabling the U-shaped base 624 to connected to the end 622 of the shaft 621.

Therefore, the coupling of the slide 623 and the groove 626 enables the U-shaped base 624 to be dismantled or connected to the end 622 of the shaft 621. The invention is designed more convenient to a driver.

With reference to FIG. 7, the main structure of a fourth preferred embodiment is the same as in the first preferred embodiment; the only difference lies in that a support bracket 631 is a flexible shaft 632, which is a metal club covered by a soft material outside, the soft material is able to be made by either rubber or plastic, or composed of a plurality of shafts. Due to the bendable property of the flexible shaft 632, a driver is able to adjust the portable electronic display device 5 (with reference to FIG. 1) to a proper visual angle; in addition, the invention is able to be bent to a proper angle not to hinder driver's view when the portable electronic display device 5 (with reference to FIG. 1) is removed from the U-shaped base 2 (with reference to FIG. 1).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An on-vehicle holder of a portable electronic display device, comprising:
a support bracket;
a U-shaped base, connected to said support bracket, comprising a first lateral plate, a second lateral plate and a bottom plate; said bottom plate is connected to said first lateral plate and said second lateral plate; a containing space portion is formed by said first lateral plate, said second lateral plate and said bottom plate; and
a movable engagement member, pivotally positioned in said second lateral plate of said U-shaped base and moved around said lateral plate, comprising an operating portion and a fastener portion;
wherein, at least either the length of said first lateral plate or the length of said second lateral plate is longer than the width of said bottom plate.

2. The on-vehicle holder of a portable electronic display device as claimed in claim 1, wherein said movable engagement member is an engagement cam and moved around corresponding to said lateral plate, when said operating portion of said movable engagement member is operated, in addition, said fastener portion is moved around toward said containing space portion.

3. The on-vehicle holder of a portable electronic display device as claimed in claim 2, wherein said fastener portion of said movable engagement member comprises a wheel pivotally set thereon.

4. The on-vehicle holder of a portable electronic display device as claimed in claim 1, wherein said support bracket is a shaft.

5. The on-vehicle holder of a portable electronic display device as claimed in claim 4, wherein said shaft comprises an end, which connects said U-shaped base.

6. The on-vehicle holder of a portable electronic display device as claimed in claim 5, wherein said end of said shaft comprises a slide, said U-shaped base comprises a groove, and said slide is correspondently coupled to said groove, enabling the coupling of said U-shaped base and said end.

7. The on-vehicle holder of a portable electronic display device as claimed in claim 5, wherein said shaft comprises a second end, which comprises a vacuum sucking disk.

8. The on-vehicle holder of a portable electronic display device as claimed in claim 7, wherein said vacuum sucking disk is formed as a plastic cup-shaped body.

9. The on-vehicle holder of a portable electronic display device as claimed in claim 8, wherein said vacuum sucking disk comprises a raised portion, said shaft pivotally set a cam thereon, said cam is positioned against said raised portion and correspondently moved around said shaft.

10. The on-vehicle holder of a portable electronic display device as claimed in claim 1, wherein said lateral plate of said U-shaped base comprises a fixed engagement member positioned on the surface facing said containing space portion.

11. The on-vehicle holder of a portable electronic display device as claimed in claim 10, wherein said fixed engagement member is at least a raised point.

12. The on-vehicle holder of a portable electronic display device as claimed in claim 1, wherein said second lateral plate of said U-shaped base comprises a through aperture, said through aperture is led to said containing space portion, said movable engagement member is pivotally positioned in said second lateral plate by piercing through said through aperture.

13. The on-vehicle holder of a portable electronic display device as claimed in claim 1, wherein said support bracket is a flexible shaft.

14. The on-vehicle holder of a portable electronic display device as claimed in claim 13, wherein said flexible shaft is a metal club covered by a soft material.

15. The on-vehicle holder of a portable electronic display device as claimed in claim 1, wherein said support bracket is composed of a plurality of shafts.

16. An on-vehicle holder of a portable electronic display device, comprising:
a support bracket, which is a shaft having a first end and a second end;
a U-shaped base being connected to said shaft through the first end and comprising a first lateral plate, a second lateral plate and a bottom plate, said bottom plate being respectively connected to said first lateral plate and said second lateral plate, a containing space portion being formed by said first lateral plate, said second lateral plate and said bottom plate;
a movable engagement member, which is an engagement cam and pivotally positioned in said second lateral plate of said U-shaped base, comprising an operating portion and a fastener portion; and
a vacuum sucking disk being connected to said shaft via said second end;
wherein at least either the length of said first lateral plate or the length of said second lateral plate is longer than the width of said bottom plate.

17. The on-vehicle holder of the portable electronic display device as claimed in claim 16, wherein said movable engagement member 3 is moved around corresponding to said second lateral plate 22 when said operating portion 31 of said movable engagement member 3 is operated, said fastener portion 32 being moved in said containing space portion 25.

18. The on-vehicle holder of the portable electronic display device as claimed in claim 16, wherein said fastener portion 32 of said movable engagement member 3 comprises a wheel 321 pivotally set thereon.

19. The on-vehicle holder of the portable electronic display device as claimed in claim 16, wherein said vacuum sucking disk is formed as a plastic cup-shaped body.

20. The on-vehicle holder of the portable electronic display device as claimed in claim 19, wherein said vacuum sucking disk comprises a raised portion, said shaft being pivotally set a cam thereon, said cam being positioned against said raised portion and correspondently moved around said shaft.

21. The on-vehicle holder of the portable electronic display device as claimed in claim 16, wherein said second lateral plate of said U-shaped base comprises a through aperture, which makes said fastener portion go through to said containing space portion.

22. An on-vehicle holder of a portable electronic display device, comprising:
a support bracket, which is a shaft having a first end and a second end;
a U-shaped base being connected to said shaft through the first end and comprising a first lateral plate, a second lateral plate and a bottom plate, said bottom plate being respectively connected to said first lateral plate and said second lateral plate, a containing space portion being formed by said first lateral plate, said second lateral plate and said bottom plate;
a movable engagement member being pivotally positioned in said second lateral plate of said U-shaped base; and
a vacuum sucking disk being connected to said shaft via said second end;
wherein at least either the length of said first lateral plate or the length of said second lateral plate is longer than the width of said bottom plate.

23. The on-vehicle holder of the portable electronic display device as claimed in claim 22, wherein said movable engagement member comprises an operating portion and a fastener portion.
